(19) United States
(12) Patent Application Publication
(10) Pub. No.: US 2024/0232848 A1
(43) Pub. Date: Jul. 11, 2024

(54) METHODS AND SYSTEMS FOR EXTENDING AGGREGATION OPTIONS

(71) Applicant: MASTERCARD INTERNATIONAL INCORPORATED, PURCHASE, NY (US)

(72) Inventor: Manu Dharmaiah Kallugudde, Maidenhead (GB)

(21) Appl. No.: 18/095,496

(22) Filed: Jan. 10, 2023

(51) Int. Cl. G06Q 20/22; G06Q 20/40; G06Q 40/03

(52) U.S. Cl. CPC G06Q 20/29; G06Q 20/40; G06Q 40/03

(57) ABSTRACT

Systems and methods are provided for use in providing aggregation to users. One example computer-implemented method includes receiving, by a computing device, an authorization request for an interaction by a user with a first party, the authorization request including an account number and a category code and identifying an aggregate profile based on the account number. In response to identifying the aggregate profile, the method the includes identifying the authorization request to the aggregate profile based on the category code being included in the aggregate profile. The method further includes transmitting, by the computing device, an approval for the authorization request and updating a balance specific to the aggregate profile and associated with a first interval based on the authorization request.

### FIELD

The present disclosure generally relates to methods and systems for use in extending aggregation options to users.

### BACKGROUND

This section provides background information related to the present disclosure which is not necessarily prior art.

Users are known to buy products (e.g., goods and services, etc.) from merchants. Often, the users fund the purchases through cash, credit, or checks, whereby the users pay full amounts for the purchases and take delivery of the products. When the users pay with credit cards, for example, the users apply credit from an account assigned to the users to purchase the products and then later pay/reimburse issuers of the credit/account for the full amounts of the purchases (potentially, with interest applied according to terms).

In addition, it is known for some merchants to offer layaway programs to users, whereby the users pay the merchants for the products over a period of time and the products are held by the merchants until all payments (or a particular number of payments) are made.

### DRAWINGS

The drawings described herein are for illustrative purposes only of selected embodiments and not all possible implementations, and are not intended to limit the scope of the present disclosure.

FIG. 1 is an example system of the present disclosure operable to provide aggregation options to users in connection with interactions by the users at first parties;

FIG. 2 is a block diagram of an example computing device that may be used in the system of FIG. 1;

FIG. 3 is an example method, which may be used with the system of FIG. 1, for providing aggregation options to users in connection with interactions by the users at first parties; and

FIG. 4 is an example interface for requesting an aggregation profile, which may be displayed to a user and used in connection with the method of FIG. 3.

Corresponding reference numerals indicate corresponding parts throughout the several views of the drawings.

### DETAILED DESCRIPTION

Example embodiments will now be described more fully with reference to the accompanying drawings.

When making purchases from merchants, users have different options to fund the purchases, including, for example, cash, credit cards, checks, etc. Installment payments are another option. In connection with installment payments, terms are typically offered to users at the time of purchase, in the form of conventional contracts. The users are then permitted to accept the terms whereby the users are responsible to make payments according to the terms. For example, in selecting an installment option for a purchase at a merchant, a user may be required to initiate four payments over a defined interval, to the merchant, whereby the purchase becomes fully funded. The merchant may then provide the purchased product/service to the user. Alternatively, installment options may be provided apart from the merchants providing the products/services, whereby third-party installment providers unrelated to the merchants fund the transactions on behalf of the users, and then the users repay the third party providers through installment payments according to associated terms. Due to a lack of integration of installment options with conventional payment processes (e.g., payment transactions for products and/or services, etc.), though, installment options may be limited and cumbersome for users, and for merchants, often resulting in friction in coordinating the installment options in the transactions, etc. Additionally, or alternatively, integration of installment payments with existing checkout functionality of merchants may be specialized, tedious, and potentially, difficult to use, manage, etc.

Uniquely, the systems and methods herein provide for aggregation of different purchases, based on, for example, a category of an aggregate profile, to consolidate purchases during an interval to a loan, whereby the purchases are paid together over time as a form of installment pay.

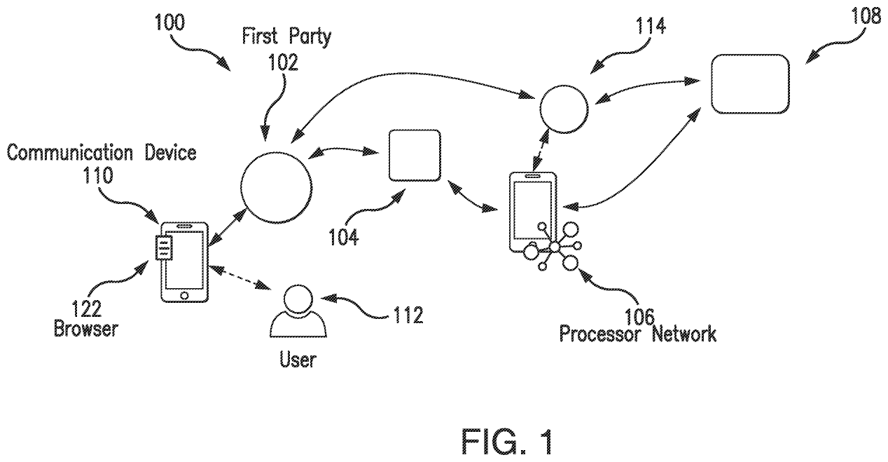

FIG. 1 illustrates an example system 100 in which one or more aspects of the present disclosure may be implemented. Although the system 100 is presented in one arrangement, other embodiments may include systems arranged otherwise depending, for example, on parties included in the system 100, processing of funding options, privacy rules and/or requirements, etc.

The illustrated system 100 generally includes a first party 102, an acquirer 104 associated with the first party 102, a processing network 106, and an account host 108, each of which is coupled to (and is in communication with) one or more networks (as generally indicated by the arrowed lines in FIG. 1). The one or more networks may each include, without limitation, a local area network (LAN), a wide area network (WAN) (e.g., the Internet, etc.), a mobile network, a virtual network, and/or another suitable public and/or private network capable of supporting communication among two or more of the parts of the system 100 illustrated in FIG. 1, or any combination thereof. For example, one such network may include multiple different networks, such as a private network made accessible by the processing network 106 to the acquirer 104 and the account host 108 and, separately, the public Internet, which is accessible as desired to the first party 102, the acquirer 104, the account host 108, and a user 112 (or specifically, a communication device 110 associated with the user 112), etc.

In the illustrated embodiment, the first party 102 in the system 100 is generally a merchant, which is configured to offer for sale and to sell products (e.g., goods, services, etc.) to consumers including, for example, to the user 112. What's more, the first party 102 may be disposed and/or accessible at one or more physical locations, such as, for example, at one or more brick-and-mortar locations, and/or at one or more virtual locations, for example, via one or more e-commerce platforms (e.g., a website accessible via browser 122, a network-based application, etc.). In connection therewith, the first party 102 is generally associated with a particular category of products, whereby the first party 102 is thus also associated with a specific category code or merchant category code (MCC). In this example (and without limitation), the first party is associated with MCC 5661 for shoe stores.

That said, the first party 102 or other first parts (or merchants) may be associated with any of the generally available MCCs, conventionally used to identify different merchants.

The acquirer 104 and account host 108 of the system 100 are financial institutions, which commonly issue accounts to various parties. In the context of FIG. 1, for example, the acquirer 104 has issued an account to the first party 102, whereupon funds from the purchase of products by users at the first party 102 (e.g., via payment account transactions, etc.) may be deposited into the first party's account at the acquirer 104. The account host 108 is configured to issue one or more payment accounts (e.g., credit accounts, debit accounts, etc.) to users, including the user 112. The payment accounts are often linked to payment devices, such as card devices, tokens, etc., whereby the users may then use the payment devices to effect purchases funded by the payment accounts.

The processing network 106 is configured to authorize, clear, and settle transactions, for example, between acquirers (e.g., the acquirer 104, etc.) and issuers (e.g., the account host 108, etc.), etc., as described in more detail below. The processing network 106 may include, for example, the MASTERCARD processing network, etc. In this example embodiment, the processing network 106 includes, or is associated with, an aggregate payment host (APH) 114, which is configured to coordinate aggregation of different transactions, based on associated rules, as described in more detail below. The APH 114 may be included, in whole or in part, in the processing network 106, or may be separate therefrom, as either a standalone entity or integrated, in whole or in part, with another entity illustrated in FIG. 1 (e.g., with the account host 108, etc.) (or otherwise), etc.

With continued reference to FIG. 1, the communication device 110 is a computing device, generally, which may include, for example, a smartphone, tablet, laptop, etc., and may alternatively include a desktop computer, etc., in other embodiments. In the system 100, the communication device 110 includes web browser 122, which configures the communication device 110 to access and to display web pages (e.g., pages hosted by the APH 114, etc.). The web browser 122 may include, for example, Microsoft Edge, Google Chrome, Apple Safari, etc. In at least one embodiment, the communication device 110 may include a mobile application associated with the account host 108 and/or the APH 114, in lieu of, or in addition to, the web browser 122.

While only one first party 102 and one user 112 are illustrated in FIG. 1, it should be appreciated that any number of first parties and/or users, as described herein, may be included in other embodiments. Likewise, a different number of acquirers, processing networks, and account hosts may be included in other system embodiments.

In this example embodiment, prior to purchase of one or more products from the first party 102, the user interacts with the APH 114 to define an aggregate profile.

In particular, in this example embodiment, the user 112 access an interface (e.g., a website, application, etc.) associated with the account host 108, via the browser 122 and communication device 110, and requests to setup the aggregate profile. In connection therewith, the user 112 identifies a specific category of merchants for aggregation, such as, for example, by MCC, or multiple MCCs, or location, or multiple locations, etc. (whereby, as will be described, the aggregated category of merchants may then be a basis for installment payments for transactions at the merchants). In response, the account host 108 is configured to submit a request for the aggregate profile to the APH 114. The request includes the category and an account number of an account issued by the account host 108 to the user 112, etc. The request may further include a maximum aggregate amount, an interval for the aggregation (e.g., ten days, fifteen days, twenty days, etc.), and also, potentially, aggregation terms (e.g., interest rate, payoff intervals (e.g., four, eight, or twelve equal payments; dates of payment; etc.), etc.

In turn, the APH 114 is configured to compile the aggregate profile for the user 112 and to store the aggregate profile in memory. The APH 114 is also configured to confirm the aggregate profile, and potentially, the terms thereof, as provided by the user 112 originally and/or as defined by the APH 114, etc.

Thereafter, the user 112 proceeds with the purchase of one or more products, which may be consistent with the merchant category or not. For the purchases consistent with the merchant category included in the aggregate profile, the first party 102, for example, is configured to compile and submit to the acquirer 104 (and processing network 106) an authorization request for the purchase, which includes the MCC(s) included in the aggregate profile (e.g., MCC 5661, etc.) and other details of the transaction, such as, for example, account number, amount, etc. In some examples, the user 112 may have multiple aggregate profiles, with each aggregate profile associated with a different category (e.g., a different MCC, a different location, etc.).

Upon receipt of the authorization request, via the acquirer 104, the processing network 106 is configured to identify the transaction based on the account number and/or the MCC, and further to identify the purchase to the aggregate profile (e.g., based on the combination of the account number and the MCC, etc.). The processing network 106 is configured to approve the transaction with the first party 102, via the acquirer 104, and potentially with the account host 108. In turn, the first party 102 completes the transaction with the user 112, whereby the user 112 takes possession of the product being purchase, in general. In addition, the processing network 106 is configured to notify the account host 108 of the transaction being approved, and also, potentially, the details of the transaction (e.g., merchant identifier, amount, etc.).

The user 112 may proceed to make multiple purchases at the first party 102 and/or other parties associated with the MCC 5661. In connection therewith, the processing network 106 is configured to proceed as above, and further to update the aggregate amount of transactions to merchants associated with MCC 5661.

The processing network 106 is configured to store the aggregate amount in memory, as the outstanding amount owed by the user 112 for a given interval (e.g., ten days, fifteen days, twenty days, etc.). At the end of the interval, the processing network 106 is configured to register a loan consistent with the aggregate profile and the current outstanding amount (e.g., with the account host 108 as the lender, etc.) and to store the loan in memory. It should be understood that the loan is registered and stored separate from the account of the user 112, whereby the loan is not part of any line of credit or available balance linked to the account. It should also be understood that when a loan exists for the aggregate profile, for the specific category, the processing network 106 may be configured to register the new loan in combination with existing loans to provide for one registered loan accounting for the full amount outstanding, or not.

Thereafter, it should be understood that repayment terms are then initiated. In particular, where the term includes six even bi-monthly payments, for example, on the first day of the following month, the processing network 106 is configured to initiate a charge to the account host 108, for a first charge consistent with the aggregate profile for the user 112 (e.g., the amount divided by six, plus interest, if applicable, etc.). The charge is paid to a lender for the loan, which in this example, is the account host 108. It should be appreciated that in other embodiments the lender may be different from the account host 108, whereby the lender is configured to fund the aggregated purchase transaction (e.g., pay the first party 102 in connection with approval, etc.) and configured to then receive repayment based on the charge to the account host 108.

Upon approval of the charge, the processing network 106 is configured to update the loan in memory to show a reduction in the amount of the loan and satisfaction of the first payment of the loan. Other updates to the loan may also be imposed, such as, for example, updating the interest rate, etc.

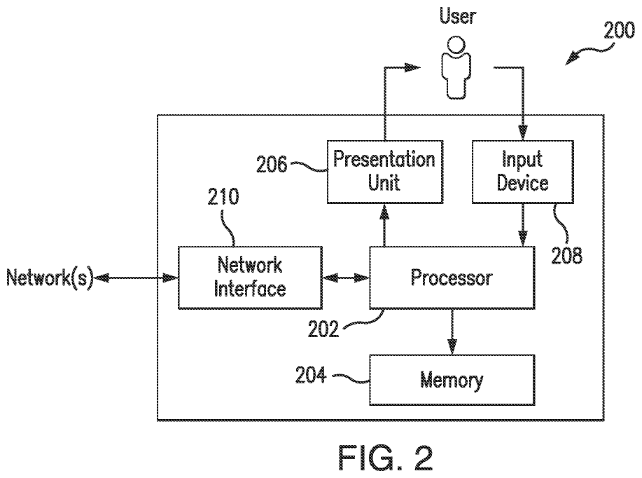

FIG. 2 illustrates an example computing device 200 that may be used in the system 100. The computing device 200 may include, for example, one or more servers, workstations, personal computers, laptops, tablets, smartphones, PDAs, terminals, virtual machines, etc. In addition, the computing device 200 may include a single computing device, or it may include multiple computing devices located in close proximity or distributed over a geographic region, so long as the computing devices are specifically configured to function as described herein. In the system 100 of FIG. 1, each of the first party 102, the acquirer 104, the processing network 106, the issuer 108, the communication device 110, and the APH 114 may include or may be implemented in a computing device (or multiple computing devices) consistent with computing device 200 coupled to (and in communication with) one or more networks. That said, the system 100, or parts thereof, should not be understood to be limited to the computing device 200, as other computing devices may be employed in other system embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, transaction data, aggregate profiles and associated parameters, MCCs, and/or other types of data (and/or data structures) as needed and/or suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special purpose computing device. It should be appreciated that the memory 204 may include a variety of different memories, each implemented in one or more of the operations or processes described herein.

In the example embodiment, the computing device 200 includes a presentation unit 206 that is coupled to (and that is in communication with) the processor 202 (however, it should be appreciated that the computing device 200 could include output devices other than the presentation unit 206, etc.). The presentation unit 206 outputs information (e.g., aggregation profile details, etc.), either visually or audibly, to a user of the computing device 200, for example, the user 112 in the system 100, etc. In connection therewith, various interfaces (e.g., as defined by a website, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user (i.e., user inputs) such as, for example, selections of aggregation options, etc. by user 112, or inputs from other computing devices. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network(s) of the system 100. Further, in some example embodiments, the computing device 200 may include the processor 202 and one or more network interfaces incorporated into or with the processor 202.

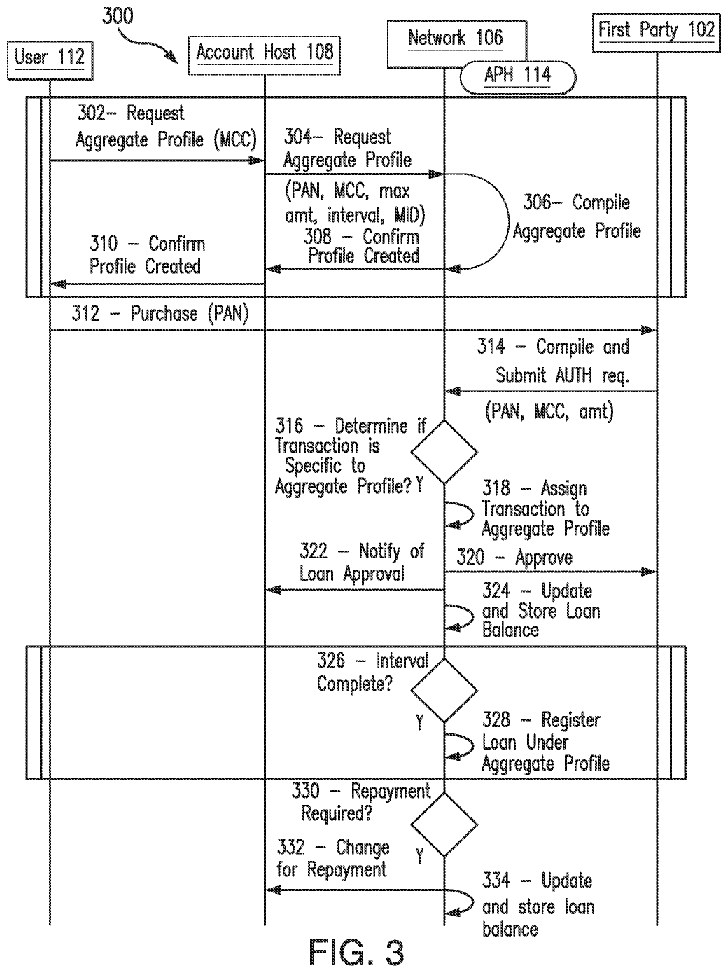

FIG. 3 illustrates an example method 300, for use in providing aggregate options to a user in connection with an interaction(s) by the user at a first party. The example method 300 is described as implemented in the system 100. Additional reference is also made to the computing device 200. Nonetheless, it should be understood that the methods herein are not limited to the system 100 and/or the computing device 200. Likewise, the systems, devices, and interfaces herein should not be understood to be limited to the method 300.

At the outset, the user 112 accesses a website associated with the APH 114, via the browser 112 at the communication device 110, to view options for aggregate profiles, whereby purchase transactions are aggregated to a loan consistent with the aggregate profile. The website may be associated directly with the APH 114, or may be linked through a website of the account host 108. For example, the user 112 may select an option for an aggregate profile at the account host's website, which directs the user 112 to the website of the APH 114. Additionally, or alternatively, the website may be offered by the account issuer, and populated with aggregate options from the APH 114. For example, the account host 114 may solicit a merchant category from the user 112, and then, communicate, as describe below, with the APH 114, etc.

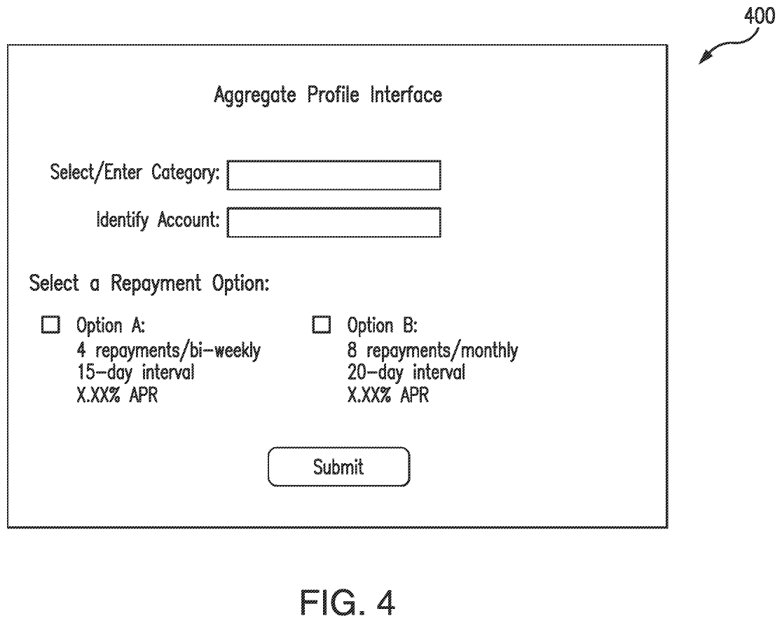

In this example embodiment, the user 112 access an interface, such as the interface 400 shown in FIG. 4. As shown, the interface 400 includes an option to enter or select a category of merchants, which may be indicated by an MCC or by a description of the category, or other otherwise. While this may be the only solicited information in one or more embodiments, in other embodiments the interface 400 may also solicit designation of a particular account (e.g., where the user 112 is issued multiple accounts by the account host 108, etc.) and selection of a repayment option. In the example interface 400, the options include a repayment term (e.g., number of repayments, timing of repayments, etc.), an aggregate interval (e.g., interval over which purchase transactions are aggregated, etc.), and an applicable interest rate. It should be appreciated that additional or different information may be included in other aggregate profile interfaces. For example, where the interface is provided from the account host 108, the interface may only solicit a category selection/entry.

With reference again to FIG. 3, when the user 112 enters/selects the information, in whole or in part, and selects the “Submit” button, the communication device 110 requests, at 302, an aggregate profile from the account host 108, where the request include the MCC or other description of the category of merchants.

While category is reference herein, it should be appreciated that a category may include a MCC, a region (e.g., all transaction within the region (e.g., city, state, postal code, etc.), etc.), or other category. In one example, then, the user 112 may aggregate all purchase while on vacation in Hawaii, for aggregation as described herein. Further, it should be appreciated that a category may also include a specific identification of a merchant (e.g., based on a merchant identifier, name, etc.), whereby only purchase transactions with that merchant would be aggregated (e.g., all transaction for “Merchant ABC,” etc.), as described herein. Further, a category may include a specific industry (e.g., home improvement, gas, groceries, etc.), whereby only purchase transactions with merchants associated with such industry would be aggregated.

It should also be appreciated that while the above is described with reference to a website, a network-based application is also suitable to be used. In one example, a network based application may be provided by the account host 108, and include a SDK specific to the aggregate profile steps described herein, and specifically, with reference to FIG. 3.

Next in the method 300, in response to the request, in this example embodiment, the account host 108 requests, at 304, the aggregate profile for the user 112, from the APH 114 (as part of the processing network 106, etc.). The request, for example, may be an application programming interface (API) call to the APH 114, or other suitable communication thereof. It should be appreciated that the request from the account host 108, in this example, includes a primary account number or PAN for the account issued by the account host 108 to the user 112 (i.e., a funding account), the MCC or other category information from the user 112, a maximum amount of the aggregation, an interval of aggregation, a repayment amount, a lender identifier, and potentially, a merchant identifier (MID) which may be used to identify a specific merchant in the actual transaction/payment authorization. The account host 108 may include any of the information not included in the request from the user 112. That is, where the user 112 includes the PAN, the account host 108 may include the PAN provided by the user 112 in the request, rather than searching for the PAN for the user 112 (e.g., based on login credentials or other identifying information from the user 112 (e.g., at the website, etc.), etc.).

In a least one embodiment, the user 112 may request the aggregate profile directly from the APH 114, whereby the account host 108 is omitted and the user 112 provides necessary information.

In turn, at 306, the APH 114 compiles the aggregate profile for the user 112 and stores the same in memory (e.g., the memory 204 thereof, etc.). It should be appreciated that either the account host 108 or the APH 114 may perform a lookup or search for associated MCC(s) when the category is identified by description or otherwise.

Once the aggregate profile is compiled, the APH 114 confirms, at 308, that the profile is created to the account host 108, which in turn, confirms, at 310, the profile is created to the user 112 (e.g., at the website at the bowser 112 of the communication device 110, etc.).

Thereafter, the user 112 may initiate purchase transactions at a number of different merchants, or first parties. As shown in FIG. 3, for example, the user 112 initiates, at 312, the purchase transaction with the first party 102, by identifying a product for purchase and presenting a payment device associated with the user's payment account (e.g., credit card, token, etc.) (i.e., issued by the account host 108 and/or included in the aggregate profile, etc.). The authorization request includes, among other things, the PAN for the account, the MCC assigned to the first party 102, and an amount, as is conventional. In other words, the first party 102 is not required to be changed in connection with this disclosure, whereby the form and/or content of the compiled authorization request is unchanged, in order for the purchase transaction to be aggregate or not. In turn, the first party 102 compiles and submits, at 314, an authorization request for the purchase transaction to the processing network 106, via the acquirer 104 (not shown).

At 316, the processing network 106 determines if the transaction is specific to an aggregate profile. In particular, in this example, the processing network 106 searches for the PAN included in the authorization request in the aggregate profile(s) in memory. If there is no match, the processing network 106 transmits the authorization request on to the account host 108, for approval, as is conventional. If there is a match, the processing network 108 determines if there is a match between the MCC in the authorization request and the MCC in the aggregate profile. If there is no match, the processing network 106 transmits the authorization request on to the account host 108, for approval, as is conventional.

If, however, there is a match, as shown in FIG. 3, the processing network 106 assigns, at 318, the purchase transaction to the aggregate profile, as approved for a loan. The processing network 106 sends an approval of the transaction to the first party 102, via the acquirer 104, at 320, whereby the transaction is funded by a lender (e.g., the account host 108, the processing network 106, etc.). The processing network 106 also notifies, at 322, the account host 108 of the loan approval for the purchase transaction and also updates and stores, at 324, the loan balance based on the amount of the transaction, for a current interval, in memory (e.g., the memory 204, etc.).

It should be appreciated that the processing network 106, in addition to identifying the aggregate profile, may apply one or more rules included herein. For example, where an aggregate profile includes a maximum amount, the processing network 106 may determine if the maximum amount will be exceeded if the purchase transaction is aggregated. The processing network 106 then proceeds to aggregate the purchase transaction on if the maximum amount will not be exceeded, and proceeds as is convention if the maximum amount will be exceeded. It should be appreciated that other rules may be employed to either aggregate or not the purchase transaction.

It should further be understood that additional transactions by the user 112 involve the repeated performance of ones of the steps between 312-324, depending on the account number included in the authorization request and/or the MCC of the first party involved in the transaction.

At 326, the processing network 106 determines that a current interval is complete. The interval may include, for example, fifteen days, twenty days, or more or less, etc. The intervals are meant to run consecutively, so that as one interval ends, and another begins. When the interval is complete, as shown, the processing network 106 registers, at 328, a loan for the user 112, under the aggregate profile, in the amount of the balance at the time that the interval completed. Registering the loan may include storing a record for the loan (e.g., in memory 204, etc.), which includes the details of the loan, the transaction forming the loan amount, etc., and also updating the loan balance for further transactions to zero.

It should be understood that when a loan for the aggregate profile already exists, the additional loan may be added to the existing loan, whereby a combined loan is stored. Additionally, or alternatively, it should be appreciated that steps 326 and 328 are performed repeatedly over time, and specifically, the registration of loans under the aggregate profile.

Once registered, the loans each enter a repayment period. In particular, at 330, the processing network 106 determines if a repayment is required based on a current time/date, in view of the repayment terms of the loan (e.g., as selected in the interface of FIG. 4, or as defined by the APH 114, etc.). If required, the processing network 106 issues, at 332, a charge to the account host 108 for a charge from the account issued by the account host 108 for the user 112 to the lender of the registered loan (e.g. based on a lender identifier, etc.) (e.g., the account host 108, a separate lender, etc.). In this way the registered loan (and associated balance due) is maintained separate from any line or credit or available balance of the account issued by the account host 108 to the user 112. In addition, upon approval thereof, the processing network 106 updates and stores, at 334, the loan balance, whereby the registered and stored loan is updated (e.g., with the account host 108, etc.) to reflect the repayment made toward the balance of the loan. The repayment period continue until the loan is paid in full.

It should be appreciated that the user 112 may have multiple loans registered at once, whereby repayment may include multiple different charges being initiated by the processing network 106 to repay the loans. The loans may be associated with the same aggregate profile, and thus same category of merchant, or different aggregate profiles, etc.

In view of the above, the systems and methods herein provide aggregate options to a user in connection with interactions by the users at a first party, through the use of aggregate profiles. The aggregate profile is stored to define rules for aggregating different transactions for the same category of merchants to a loan, which is automatically registered based on an interval and repaid over a repayment period, thereby providing for installment repayment of the aggregate transactions. The aggregate profile leverages conventional authorization requests to trigger the aggregation, whereby the first party (or merchant) is permitted to proceed as conventional, while the extended functionality of the aggregate profile is implemented in the intermediate, i.e., the processing network, or potentially, the issuer or account host, etc. This provides for an efficient network topology, which is essentially unchanged, while extending the technical functionality of the same to provide aggregation of different transactions in a manner not previously permitted, offered and/or possible.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims including, for example, one or more of the following operations: (a) receiving an authorization request for an interaction by a user with a first party, the authorization request including an account number and a category code; (b) identifying an aggregate profile based on the account number; (c) in response to identifying the aggregate profile, identifying the authorization request to the aggregate profile based on the category code being included in the aggregate profile; (d) transmitting an approval for the authorization request; (e) updating a balance specific to the aggregate profile and associated with a first interval based on the authorization request (f) determining that the first interval is complete; (g) registering a loan for the aggregate profile, which includes the balance specific to the aggregate profile and associated with the first interval; (h) determining that a repayment is required based on the registered loan for the aggregate profile and a current date/time; (i) initiating a charge to an account associated with the account number for a repayment amount; (j) receiving a request for the aggregate profile, the request including the category code; and/or (k) store the aggregate profile with the category code in memory, prior to receiving the authorization request.

With that said, example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a.” “an,” and “the” may be intended to include the plural forms as well, unless the context clearly indicates otherwise. The terms “comprises,” “comprising.” “including.” and “having.” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on.” “engaged to.” “connected to,” “coupled to,” “included with,” “associated with,” or “in communication with” another feature, element or layer, it may be directly on, engaged, connected, coupled, associated, or in communication with/to the other feature, element or layer, or intervening features, elements or layers may be present. In contrast, when feature, element or layer is referred to as being “directly on,” “directly engaged to,” “directly connected to,” “directly coupled to,” “directly associated with,” or “directly in communication with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the example embodiments.

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing aggregation to users, the method comprising:
receiving, by a computing device, an authorization request for an interaction by a user with a first party, the authorization request including an account number and a category code;
identifying, by the computing device, an aggregate profile based on the account number;
in response to identifying the aggregate profile, identifying the authorization request to the aggregate profile based on the category code being included in the aggregate profile;
transmitting, by the computing device, an approval for the authorization request; and
updating a balance specific to the aggregate profile and associated with a first interval based on the authorization request.

2. The computer-implemented method of claim 1, wherein the authorization request further includes an amount; and
wherein updating the balance specific to the aggregate profile and associated with the first interval includes incrementing the balance by said amount.

3. The computer-implemented method of claim 2, wherein the account number includes a primary account number (PAN) for a payment account; and
wherein the category code includes a merchant category code (MCC) and/or a postal code.

4. The computer-implemented method of claim 1, further comprising:
determining that the first interval is complete; and then
registering a loan for the aggregate profile, which includes the balance specific to the aggregate profile and associated with the first interval.

5. The computer-implemented method of claim 4, wherein the registered loan includes a repayment amount and a term at which the repayment amount is required.

6. The computer-implemented method of claim 5, further comprising:
determining that a repayment is required based on the registered loan for the aggregate profile and a current date/time; and then
initiating a charge to an account associated with the account number for a repayment amount.

7. The computer-implemented method of claim 1, further comprising:
receiving a request for the aggregate profile, the request including the category code; and
store the aggregate profile with the category code in memory, prior to receiving the authorization request.

8. The computer-implemented method of claim 7, wherein receiving the request includes receiving the request as an application programming interface (API) call, from an account host, which issued the account number.

9. A non-transitory computer-readable storage medium including executable instructions for use in providing aggregation to users, which when executed by at least one processor, cause the at least one processor to:
receive, from a first party, an authorization request for a transaction, the authorization request including an account number of an account and a category code;
identify an aggregate profile, in a memory associated with the at least one processor, based on the account number;
in response to identifying the aggregate profile, identify the transaction for aggregating to the aggregate profile based on the category code being the same as a category code included in the aggregate profile;
transmit an approval for the transaction back to the first party; and
update a balance specific to the aggregate profile and associated with a first interval based on the authorization request.

10. The non-transitory computer-readable storage medium of claim 9, wherein the executable instructions, when executed by the at least one processor, cause the at least one processor to:
determine that the first interval is complete; and then
register a loan for the aggregate profile, which includes the balance specific to the aggregate profile and associated with the first interval.

11. The non-transitory computer-readable storage medium of claim 10, wherein the authorization request further includes an amount; and
wherein the executable instructions, when executed by the at least one processor, cause the at least one processor, in connection with updating the balance, to increment the balance by said amount.

12. The non-transitory computer-readable storage medium of claim 10, wherein the registered loan includes a repayment amount and a term at which the repayment amount is required.

13. A system for use in providing aggregation to users, the system comprising at least one computing device configured to:
receive, from a first party, an authorization request for a transaction, the authorization request including an account number of an account and a category code;
identify an aggregate profile, in a memory associated with the at least one processor, based on the account number;
in response to identifying the aggregate profile, identify the transaction for aggregating to the aggregate profile based on the category code being the same as a category code included in the aggregate profile;
transmit an approval for the transaction back to the first party; and
update a balance specific to the aggregate profile and associated with a first interval based on the authorization request.

14. The system of claim 13, wherein the at least one computing device is further configured to:
determine that the first interval is complete; and then
register a loan for the aggregate profile, which includes the balance specific to the aggregate profile and associated with the first interval.

15. The system of claim 14, wherein the authorization request further includes an amount; and
wherein the at least one computing device is further configured, in connection with updating the balance, to increment the balance by said amount.

16. The system of claim 14, wherein the registered loan includes a repayment amount and a term at which the repayment amount is required.
